(19) United States
(12) Patent Application Publication
(10) Pub. No.: US 2025/0360942 A1
(43) Pub. Date: Nov. 27, 2025

(54) VEHICLE AND VEHICLE CONTROL INTERFACE

(71) Applicant: TOYOTA JIDOSHA KABUSHIKI KAISHA, Toyota-shi (JP)

(72) Inventors: Ikuma SUZUKI, Okazaki-shi (JP); Hirohito IDE, Nagoya-shi (JP)

(73) Assignee: TOYOTA JIDOSHA KABUSHIKI KAISHA, Toyota-shi (JP)

(21) Appl. No.: 19/021,794

(22) Filed: Jan. 15, 2025

(30) Foreign Application Priority Data
May 22, 2024 (JP) 2024-082993

(51) Int. Cl. B60W 60/00; B60R 16/023

(52) U.S. Cl. CPC B60W 60/001; B60R 16/0231

(57) ABSTRACT

The vehicles are configured to be capable of mounting an ADK. The vehicle includes a ADK that executes vehicle control in accordance with a command from VP, and a VCIB that performs an interface between ADK and VP by communication through the main bus or through the sub-bus. When communication via the main bus is interrupted, VCIB starts communication via the sub bus, and thereafter, when communication via the main bus becomes possible prior to the elapse of the predetermined period, it starts communication via the main bus, and when the predetermined period elapses, it continues communication via the sub bus regardless of whether communication via the main bus is possible.

### CROSS-REFERENCE TO RELATED APPLICATION

This application claims priority to Japanese Patent Application No. 2024-082993 filed on May 22, 2024, incorporated herein by reference in its entirety.

### BACKGROUND

### 1. Technical Field

The present disclosure relates to a vehicle and a vehicle control interface, and more particularly, to a vehicle on which an autonomous driving system can be mounted, and a vehicle control interface that provides an interface between the autonomous driving system and a vehicle platform.

### 2. Description of Related Art

Japanese Unexamined Patent Application Publication No. 2018-132015 (JP 2018-132015 A) discloses a vehicle on which an autonomous driving system is mounted. The autonomous driving system includes a camera, a laser device, a radar device, an operating device, a gradient sensor, an autonomous driving device, and an autonomous driving electronic control unit (ECU) (see paragraph of JP 2018-132015 A).

### SUMMARY

It is conceivable to provide the autonomous driving system externally to the vehicle platform. In this case, autonomous driving is realized by the vehicle platform operating in accordance with a command from the autonomous driving system. Such an autonomous driving system will be hereinafter also referred to as “autonomous driving kit (ADK).” The vehicle platform will be also referred to as “VP.”

It is desirable that an appropriate interface be provided between the ADK and the VP for appropriate coordination between the ADK and the VP. Such an interface will be referred to as “vehicle control interface.” The vehicle control interface can be particularly important when an ADK developer (e.g., a venture company) differs from a VP developer (typically a finished vehicle manufacturer).

It is conceivable that a communication system between the ADK and the vehicle control interface is duplicated (made redundant). One of the duplicated communication systems will be referred to as “main system” and the other will be referred to as “sub-system.”

Communication between the ADK and the vehicle control interface in a normal state is performed via the main system. When any failure occurs in the main system and the communication via the main system is interrupted, the communication between the ADK and the vehicle control interface is switched from the communication via the main system to the communication via the sub-system.

After the switching to the sub-system, the main system may recover from the failure and be able to perform communication. The inventors have found a problem that, in such circumstances, it may be necessary to appropriately select the communication system between the ADK and the vehicle control interface in order to appropriately perform the vehicle control in the VP.

The present disclosure has been made to solve the above problem, and an object of the present disclosure is to appropriately perform vehicle control in a vehicle platform (VP).

A vehicle according to an aspect of the present disclosure is configured such that an autonomous driving system is mountable. The vehicle includes:
a vehicle platform configured to perform vehicle control in accordance with a command from the autonomous driving system; and
a vehicle control interface configured to provide an interface between the autonomous driving system and the vehicle platform by communication via a main system or via a sub-system. The vehicle control interface is configured to:
start the communication via the sub-system when the communication via the main system is interrupted; and
start the communication via the main system when the communication via the main system is possible before a predetermined period elapses after the communication via the sub-system has been started, and continue the communication via the sub-system when the predetermined period has elapsed, regardless of whether the communication via the main system is possible.

A vehicle control interface according to another aspect of the present disclosure is configured to provide an interface between an autonomous driving system and a vehicle platform. The vehicle control interface includes a processor configured to perform communication with the autonomous driving system via a main system or via a sub-system. The processor is configured to:
start the communication via the sub-system when the communication via the main system is interrupted; and
start the communication via the main system when the communication via the main system is possible before a predetermined period elapses after the communication via the sub-system has been started, and continue the communication via the sub-system when the predetermined period has elapsed, regardless of whether the communication via the main system is possible.

According to the present disclosure, it is possible to appropriately perform the vehicle control in the VP.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating an overall configuration of a vehicle according to an embodiment of the present disclosure;

FIG. 2 is a more detailed view of the configuration of an ADK, a vehicle platform (VP), and a vehicle control interface (VCIB);

FIG. 3 is a diagram illustrating a communication system between an ADK, a VP, and a VCIB;

FIG. 4 is a flow chart illustrating an exemplary process at the time of starting communication according to the present embodiment; and

FIG. 5 is a flowchart illustrating an example of a processing procedure of the communication system selection according to the present embodiment.

### DETAILED DESCRIPTION OF EMBODIMENTS

Hereinafter, embodiments of the present disclosure will be described in detail with reference to the drawings. In the drawings, the same or corresponding portions are denoted by the same reference signs and the description thereof will not be repeated.

### EMBODIMENT

### Overall Configuration

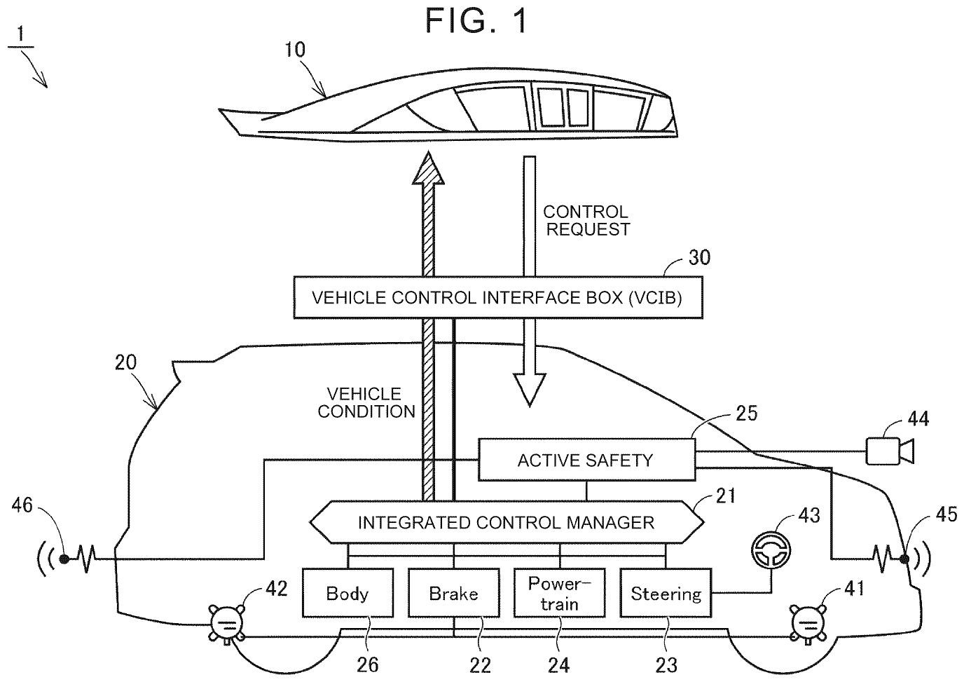

FIG. 1 is a diagram schematically illustrating an overall configuration of a vehicle according to an embodiment of the present disclosure. The vehicle 1 includes an autonomous driving kit (ADK) 10, a vehicle platform (VP) 20, and a vehicle control interface (VCIB: Vehicle Control Interface Box) 30. the ADK 10 and the VP 20 are communicably connected to each other via a vehicle control interface 30.

the ADK 10 includes an autonomous driving system for performing autonomous driving of the vehicle 1. the ADK 10 creates, for example, a travel plan (trip) of the vehicle 1. the ADK 10 outputs various control requests for causing the vehicle 1 to travel in accordance with the travel plan to the VP 20 in accordance with an API (Application Program Interface) defined for each control request. Further, the ADK 10 receives various signals indicating the vehicle state (the VP 20 state) from the VP 20 according to an API defined for each signal. Then, the ADK 10 reflects the condition of the vehicle in the travel plan.

the VP 20 performs various vehicle controls according to control requirements from the ADK 10. the VP 20 includes various in-vehicle systems and various sensors. More specifically, the VP 20 includes an integrated control manager 21, a brake system 22, a steering system 23, a powertrain system 24, and an active safety system 25. Further, the VP 20 includes a body system 26, wheel speed sensors 41 and 42, a pinion angle sensor 43, a camera 44, and radar sensors 45 and 46.

The integrated control manager 21 includes a processor such as CPU (Central Processing Unit) and memories such as ROM (Read Only Memory) and RAM (Random Access Memory), all of which are not shown. The integrated control manager 21 integrates and controls the respective systems (the brake system 22, the steering system 23, the powertrain system 24, the active safety system 25, and the body system 26) related to the operation of the vehicle 1.

the VCIB 30 is configured to be able to communicate with the ADK 10 through CAN (Controller Area Network) or the like. the VCIB 30 executes a predetermined API defined for each signal, and thereby receives a control request from the ADK 10 and outputs the vehicle status to the ADK 10. When receiving a control request from the ADK 10, the VCIB 30 outputs a control command corresponding to the control request to the control command via the integrated control manager 21. Further, the VCIB 30 acquires various types of information of the VP 20 from various systems via the integrated control manager 21, and outputs the state of the VP 20 to the ADK 10 as a vehicle state.

the ADK 10 is configured to be attachable to (mounted on) and detachable from the VP 20. Although the ADK 10 is shown in FIG. 1 in a position away from the VP 20, the ADK 10 is actually attached to a rooftop or the like of the VP 20. When the ADK 10 is removed, the VP 20 performs travel control (travel control according to user manipulation) in the manual mode.

### Configuration of Each Component

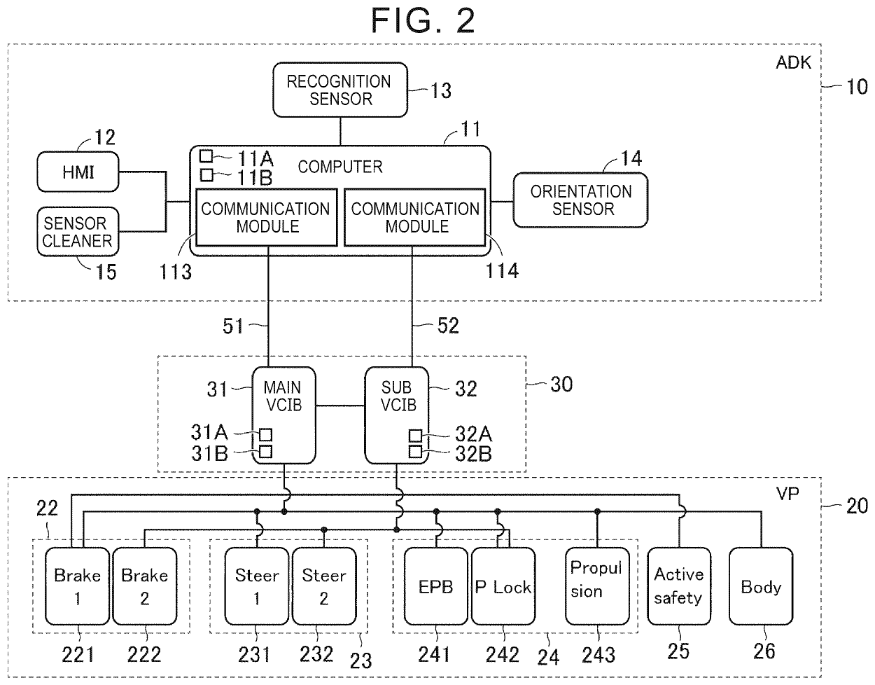

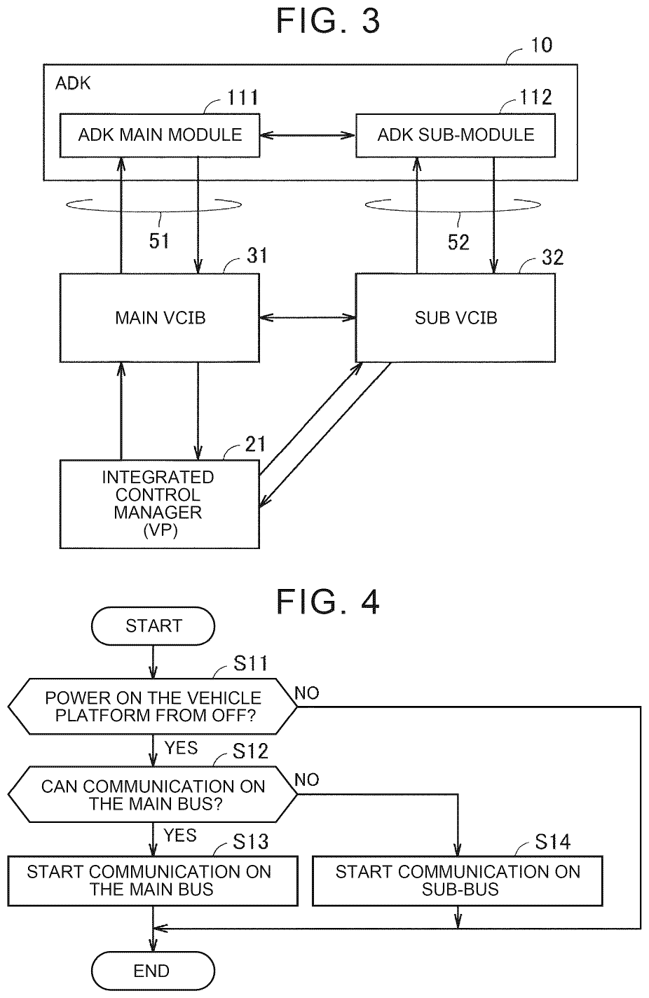

FIG. 2 is a diagram illustrating a configuration of a the ADK 10, the VP 20 and a the VCIB 30 in more detail. FIG. 3 is a diagram for explaining a communication system between the ADK 10, the VP 20, and the VCIB 30.

Referring to FIGS. 2 and 3, the ADK 10 includes a computer 11, a human machine interface (HMI: Human Machine Interface) 12, a recognizing sensor 13, an attitude sensor 14, and a sensor cleaner 15.

The computer 11 includes a processor 11A such as a CPU and a memory 11B such as a ROM and a RAM. The memory 11B stores programs executable by the processor 11A. The computer 11 acquires the environment of the vehicle 1 and the attitude, behavior, and position of the vehicle 1 by using various sensors during automatic driving of the vehicle 1. Further, the computer 11 acquires the vehicle status from the VP 20 through the VCIB 30 and sets the subsequent operation (acceleration, deceleration, bending, and the like) of the vehicle 1. The computer 11 outputs various control demands for realizing the following operations to the VCIB 30.

The computer 11 further includes a ADK main module 111, a ADK sub-module 112, a communication module 113, and a communication module 114. ADK main module 111 is configured to communicate with the main the VCIB 31 via the communication module 113. ADK sub-module 112 is configured to be able to communicate with the sub VCIB 32 via the communication module 114. Further, ADK main module 111 and ADK sub-module 112 are communicably connected to each other.

In the VP 20, the brake system 22 includes brake systems 221,222. The steering system 23 includes a steering system 231,232. The powertrain system 24 includes an electric parking (EPB: Electrical Parking Brake) system 241, a parking lock (P-Lock) system 242, and a propulsion system 243.

the VCIB 30 includes a main the VCIB 31 and a sub VCIB 32. The main the VCIB 31 includes a processor 31A, such as a CPU, and a memory 31B, such as a ROM and RAM. The memory 31B stores programs executable by the processor 31A. Similarly, the sub-processor includes a processor 32A and a VCIB 32 of 32B. The memory 32B stores programs executable by the processor 32A.

Each of the main the VCIB 31 and the sub VCIB 32 relays a control demand between the ADK 10 and the VP 20 and information indicating the vehicle status. The main the VCIB 31 and ADK main module 111 are connected to each other by a main bus (corresponding to a “main system” according to the present disclosure) 51 so as to be able to communicate with each other. The main the VCIB 31 interfaces between the VP 20 and the ADK 10 (ADK main module 111) through the main bus 51. The sub VCIB 32 and ADK sub module 112 are connected to each other by a sub-bus (corresponding to a “sub-system” according to the present disclosure) 52 so as to be able to communicate with each other. The sub VCIB 32 interfaces between the VP 20 and the ADK 10 (ADK sub-module 112) through the sub-bus 52. Further, the main the VCIB 31 and the sub VCIB 32 are communicably connected to each other.

The main the VCIB 31 and the sub VCIB 32 have basically the same functions. However, the main the VCIB 31 and the sub VCIB 32 are partially connected to the VP 20. Specifically, the main the VCIB 31, the brake system 221, the steering system 231, EPB system 241, P-Lock system 242, the propulsion system 243, and the body system 26 are communicably connected to each other via a communication bus. The sub VCIB 32, the brake system 222, the steering system 232, and P-Lock system 242 are communicably connected to each other via a communication bus.

As described above, in the vehicle 1, the main the VCIB 31 and the sub VCIB 32 have the same functions with respect to the operation (braking, steering, and the like) of some systems. In addition, the ADK 10 includes a ADK main module 111 and a ADK sub-module 112, and the ADK 10 and the VP 20 are connected to each other by a main bus 51 and a sub-bus 52. As a result, the ADK 10, the VP 20 and the VCIB 30 are redundantly configured.

### Communication Interruption and Recovery

The communication between the ADK 10 and the VCIB 30 in the normal state is performed through the main bus 51. When a failure occurs in the main bus 51 and communication via the main bus 51 is interrupted, communication between the ADK 10 and the VCIB 30 is switched from via the main bus 51 to via the sub-bus 52.

After switching via the sub-bus 52, for example, the power supply of the main bus 51 is reset, so that the main bus 51 may recover from a failure and be able to communicate. In this situation, it is conceivable to return the communication between the ADK 10 and the VCIB 30 from the sub-bus 52 to the main bus 51.

However, when the main bus 51 recovers from the failure, there is a possibility that information (such as a self-position) necessary for the automatic driving of the vehicle 1 is lost due to the power reset of the main bus 51. In addition, there is a possibility that the ADK 10 (ADK main module 111) returns to the initial status. Then, the reliability of the control request given from the ADK 10 to the VP 20 through the main bus 51 is low, and the possibility that the control request is not appropriate cannot be denied. Consequently, proper control of vehicles in the VP 20 may be difficult.

Therefore, in the “communication system selection” according to the present embodiment, it is considered that there is a possibility that the ADK 10 (ADK main module 111) has failed when a predetermined period has elapsed after switching to the sub-bus 52 due to the communication interruption of the main bus 51. Then, communication via the sub-bus 52 is continued. Hereinafter, this process will be described in detail.

### Process Flow

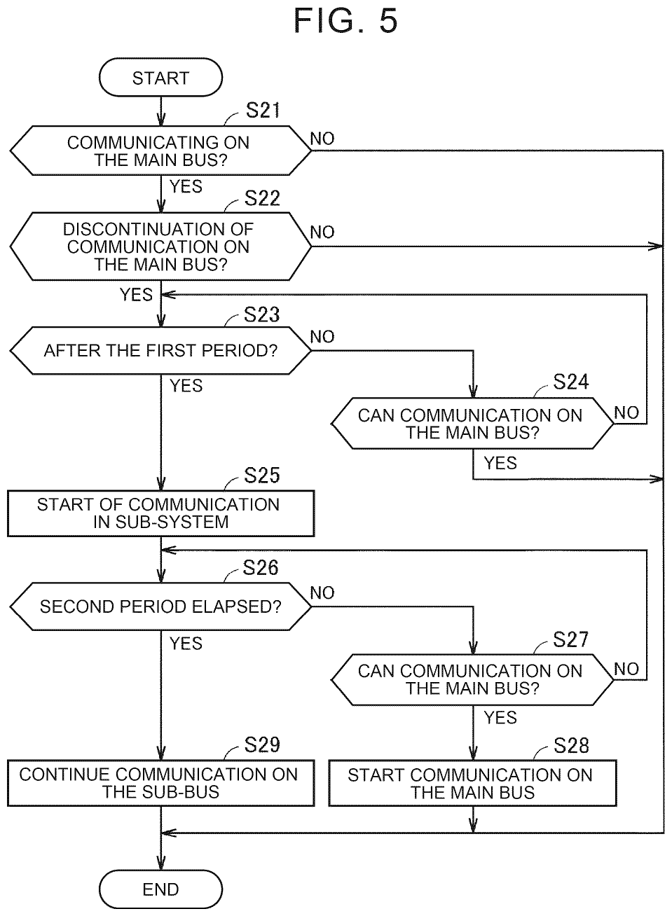

FIG. 4 is a flowchart illustrating an example of a processing procedure at the time of starting communication according to the present embodiment. When a predetermined condition is satisfied, for example, after completion of the travel planning by the ADK 10, the process illustrated in this flow chart is called and executed from a main routine (not illustrated) at predetermined intervals. The steps are realized by software processes by the VCIB 30 (main the VCIB 31 and sub VCIB 32), but some or all of them may be realized by hardware (electric circuitry) arranged in an ECU. The same applies to the flowchart of FIG. 5 described later. Hereinafter, the step is abbreviated as S.

Referring to FIGS. 3 and 4, in S11, the VCIB 30 determines whether the VP 20 has been powered on (whether it has switched from powered off to powered on). If the VP 20 is not powered on (NO in S11), the VCIB 30 skips the subsequent processing and returns the processing to the main routine.

When the VP 20 is powered on (YES in S11), the VCIB 30 determines whether communication between the ADK 10 and the VCIB 30 is enabled through the main bus 51 (S12). When communication via the main bus 51 is enabled (YES in S12), the VCIB 30 starts communication via the main bus 51 between the ADK 10 and the VCIB 30 (S13). On the other hand, when communication via the main bus 51 is not enabled (NO in S12), the VCIB 30 starts communication via the sub-bus 52 between the ADK 10 and the VCIB 30 (S14).

FIG. 5 is a flowchart illustrating an example of a processing procedure of the communication system selection according to the present embodiment. Referring to FIGS. 3 and 5, in S21, the VCIB 30 determines whether the ADK 10 and the VCIB 30 are communicating through the main bus 51. When the ADK 10 and the VCIB 30 are not communicating via the main bus 51 (NO in S21), that is, when the communication is being performed via the sub-bus 52, the VCIB 30 skips the subsequent processing and returns the processing to the main routine.

When the ADK 10 and the VCIB 30 are communicating via the main bus 51 (YES in S21), the VCIB 30 determines whether the communication via the main bus 51 has been interrupted due to some failure (S22). When the communication through the main bus 51 is not interrupted (NO in S22), the VCIB 30 returns the process to the main routine.

When communication through the main bus 51 is interrupted (YES in S22), the VCIB 30 determines whether or not a period during which communication is interrupted (communication interruption period) is longer than a predetermined first period (S23).

When the communication interruption period is equal to or less than the first period (NO in S23), the VCIB 30 determines whether communication through the main bus 51 is enabled (whether or not the main bus 51 has recovered from the failure) (S24). When communication through the main bus 51 is enabled (YES in S24), the VCIB 30 returns the process to the main routine. In this case, communication via the main bus 51 is resumed. When communication through the main bus 51 is not enabled (NO in S24), the VCIB 30 returns the process to S23. As a result, an attempt to resume communication via the main bus 51 is continued.

When the communication interruption period is longer than the first period (YES in S23), the VCIB 30 starts communication between the ADK 10 and the VCIB 30 through the sub-bus 52 (S25). That is, the VCIB 30 switches the communication from the main bus 51 to the sub-bus 52.

In S26, the VCIB 30 determines whether or not a period after the communication is switched from the main bus 51 to the sub-bus 52 (a period after the switching) is longer than a predetermined second period. The second period may be defined as a period shorter than a period required for resetting the power supply of the ADK 10 (ADK main module 111). The second period corresponds to a “predetermined period” according to the present disclosure.

When the period after the switching is equal to or less than the second period (NO in S26), the VCIB 30 determines whether communication through the main bus 51 is enabled (whether or not the main bus 51 has recovered from the failure) (S27). When communication via the main bus 51 is enabled (YES in S27), the VCIB 30 starts communication via the main bus 51 between the ADK 10 and the VCIB 30 (S28). When communication through the main bus 51 is not enabled (NO in S27), the VCIB 30 returns the process to S26.

If the time period after the switching is longer than the second period (YES in S26), there is a possibility that ADK main module 111 has failed or the power supply of ADK main module 111 has been reset. Therefore, the VCIB 30 continues communication between the ADK 10 and the VCIB 30 through the sub-bus 52 (S29). In other words, the VCIB 30 selects communication via the sub-bus 52 regardless of whether communication via the main bus 51 is enabled or not. the VCIB 30 continues communication through the sub-bus 52 until the travel planning by the ADK 10 is completed.

As described above, in the present embodiment, the communication between the ADK 10 and the VCIB 30 is switched from the main bus 51 to the sub-bus 52 due to the communication interruption of the main bus 51. After that, when the second time has elapsed, the communication via the main bus 51 is not performed, and the communication via the sub-bus 52 is continued, considering the possibility of the power resetting or the failure of ADK main module 111. This is because the control request from ADK sub-module 112 is more reliable than the control request from ADK main-module 111. Therefore, according to the present embodiment, it is possible to appropriately select a communication system between the ADK 10 and the VCIB 30, and thereby to appropriately control vehicles in the VP 20.

It is to be understood that the embodiments disclosed herein are illustrative and non-restrictive in all respects. It is intended that the scope of the disclosure be defined by the appended claims rather than the description of the embodiments described above, and that all changes within the meaning and range of equivalency of the claims be embraced therein.

What is claimed is:

1. A vehicle configured such that an autonomous driving system is mountable, the vehicle comprising:
a vehicle platform configured to perform vehicle control in accordance with a command from the autonomous driving system; and
a vehicle control interface configured to provide an interface between the autonomous driving system and the vehicle platform by communication via a main system or via a sub-system, wherein the vehicle control interface is configured to:
start the communication via the sub-system when the communication via the main system is interrupted; and
start the communication via the main system when the communication via the main system is possible before a predetermined period elapses after the communication via the sub-system has been started, and continue the communication via the sub-system when the predetermined period has elapsed, regardless of whether the communication via the main system is possible.

2. The vehicle according to claim 1, wherein the vehicle control interface is configured to, after the predetermined period has elapsed, continue the communication via the sub-system until a travel plan is completed by the autonomous driving system.

3. The vehicle according to claim 2, wherein the vehicle control interface is configured to, after the travel plan has been completed, perform the communication via the main system when power of the vehicle platform is switched from OFF to ON and the communication via the main system is possible.

4. A vehicle control interface configured to provide an interface between an autonomous driving system and a vehicle platform, the vehicle control interface comprising a processor configured to perform communication with the autonomous driving system via a main system or via a sub-system, wherein the processor is configured to:
start the communication via the sub-system when the communication via the main system is interrupted; and
start the communication via the main system when the communication via the main system is possible before a predetermined period elapses after the communication via the sub-system has been started, and continue the communication via the sub-system when the predetermined period has elapsed, regardless of whether the communication via the main system is possible.
